(19) United States
(12) Patent Application Publication
(10) Pub. No.: US 2003/0046357 A1
(43) Pub. Date: Mar. 6, 2003

(54) Intelligent content placement in a distributed computing network

(75) Inventors: Ronald P. Doyle, Raleigh, NC (US); David L. Kaminsky, Chapel Hill, NC (US); Rashmi Patel, Cary, NC (US)

Correspondence Address: Jeanine S. Ray-Yarletts, IBM Corporation, T81/503, PO Box 12195, Research Triangle Park, NC, 27709, US

(73) Assignee: International Business Machines Corporation, Armonk, NY (US)

(21) Appl. No.: 09/943,560

(22) Filed: Aug. 30, 2001

(51) Int. Cl. G06F 15/167; G06F 15/173

(52) U.S. Cl. 709/214; 709/226

(57) ABSTRACT

Techniques are disclosed for storing document content in a manner which improves efficiency and/or speed of servicing content requests. Expected and/or observed popularity of stored objects is used to determine where a particular object should be physically placed in a distributed computing network. The disclosed techniques may be used for initially placing objects and/or for subsequently placing objects at different and/or additional locations in the network.

### BACKGROUND OF THE INVENTION

1. Field of the Invention

The present invention relates to distributed computing networks, and deals more particularly with storing document content in a manner which improves efficiency and/or speed of servicing content requests.

2. Description of the Related Art

The popularity of distributed computing networks and network computing has increased tremendously in recent years, due in large part to growing business and consumer use of the public Internet and the subset thereof known as the “World Wide Web” (or simply “Web”). Other types of distributed computing networks, such as corporate intranets and extranets, are also increasingly popular. As solutions providers focus on delivering improved Web-based computing, many of the solutions which are developed are adaptable to other distributed computing environments. Thus, references herein to the Internet and Web are for purposes of illustration and not of limitation.

The early Internet served primarily as a distributed file system in which users could request delivery of already-generated static documents. In recent years, the trend has been to add more and more dynamic and personalized aspects into the content that is served to requesters. However, many dynamically-generated documents also include static content, such as forms, graphic images, sound files, and other types of embedded objects. (References herein to already-generated static content are intended to refer equivalently to static content which is incorporated into dynamically-generated documents or other types of dynamically-generated content.)

The number of objects involved in servicing a content request may range from a single stored object to a relatively large number of objects (often, on the order of tens of objects). (The terms “stored object” and “object” are used interchangeably herein to refer to an object or file which is stored on a storage medium—or which may, in some cases, be distributed across more than one storage medium. It should be noted that references herein to objects are not to be construed as limiting the present invention to the field of object-oriented programming. Furthermore, the terms “content” and “document content” as used herein are intended to be synonymous with one or more objects or files unless the reference context indicates otherwise.) Studies show that requests for objects generally follow a very distinct statistical distribution pattern. That is, in an average content distribution environment, there are typically a large number of requests for a relatively small number of objects, while there are a smaller number of requests for a much larger population of the objects. This distribution pattern for content requests generally follows what is known as a “Zipf distribution” (or a “Zipf-like” distribution). A Zipf distribution is a particular type of distribution pattern, wherein a double-logarithmic plotting of the distribution follows a straight line. Papers discussing the Zipf-like distribution of content requests include “Zipf Curves and Website Popularity”, published on the Internet at location http://www.useit.com/alertbox/zipf.html (Apr. 15, 1997) and “Do Websites Have Increasing Returns”, Jakob Nielsen, published on the Internet at location http://www.useit.com/alertbox/9704b.html (Apr. 15, 1997).

While some content requests are generated programmatically, many content requests have a human user waiting for a response. Returning responses quickly and efficiently can therefore be critical to user satisfaction and to the overall success of a Web site. An additional concern in a distributed computing environment is the processing load on the computing resources. If a bottleneck occurs, overall system throughput may be seriously degraded. To address this situation, the content supplier may have to purchase additional servers, which increases the cost of doing business.

FIG. 1 provides a diagram of a representative server site 100 in which a content request is serviced. (The term “server site” as used herein refers to a collection of server nodes that serve Web content associated with a given fully-qualified domain name. For example, the server site 100 in FIG. 1 may, for purposes of example, serve content for a domain name such as “www.ibm.com”.) In this example, a content request 110 is transmitted from a client (not shown) through a network such as the Internet 120 and then to a load balancing host 130 (that is, a computing device which distributes incoming requests across a plurality of Web servers 140 to balance the processing load). The load balancing host 130 may then select one of the Web servers 140 (such as Apache, Netscape, or Microsoft servers), according to the load balancing strategy which has been implemented in host 130. To serve the requested content, a particular Web server may invoke the services of an application server (such as a WebSphere® application server which is available from the International Business Machines Corporation, or “IBM”), where this application server may be co-located with the Web server 140 in a single hardware box or may be located at a different device 150. The Web server may also or alternatively invoke the services of a back-end enterprise data server 160 (such as an IBM OS/390® server running the DB/2, CICS®, and/or MQI products from IBM), which may in turn access one or more databases 170 or other data repositories. (“WebSphere”, “OS/390”, and “CICS” are registered trademarks of IBM.)

The load balancing host 130 may also function as a surrogate (reverse proxy cache) or forward proxy cache (and these terms, or the term “cache server”, are used interchangeably herein). The IBM WebSphere Edge Server is one implementation which provides this combined functionality. For example, it may be possible in some cases to serve the requested content from cache storage which is accessible to host 130, rather than sending the content request on to a Web server 140. Or, a cache server might be located elsewhere in the network path between the content requester and the Web server(s). For example, a cache server might be encountered before a content request 110 reaches a load balancing host 130.

A technique that goes a long way toward improving performance in a distributed computing environment is to combine (1) caching to reduce the number of requests that reaches the Web servers, thereby improving response time and reducing processing load, and (2) workload balancing to attempt evenly distributing content requests among a cluster of Web servers. However, in many cases, there is room for improvement. Content might not be cached if it is too large. There may also be some situations in which caching is ineffective. For example, content might be specified as not cachable for one reason or another. Or, there might be dynamically-generated elements in popular content which effectively prevents its being served from cache. When content cannot be served from cache, the content requests come to a Web server—which, in many cases, subsequently routes the content requests to network-attached storage (“NAS”) or a NAS system.

NAS systems may be thought of as servers which are dedicated to file storage and retrieval, and typically use a combination of hardware and software to service file requests. The hardware generally comprises persistent storage devices such as disk drives (and in particular, high-volume storage devices such as “redundant array of independent disk” or “RAID” devices) which store the file content. Typically, the NAS system is given its own network address, and the NAS system's software is responsible for determining the mapping between a particular network address from an incoming content request and a corresponding location on a storage device where content is to be stored in the case of a storage request, or where content resides which can be used in serving a content retrieval request. NAS systems improve operations in distributed computing networks by offloading file storage and retrieval operations from Web servers, enabling the Web servers to scale more easily (that is, to effectively handle a higher volume of content requests).

FIG. 2 illustrates a distributed computing network 200 which includes NAS (shown generally as NAS system 250). Client computers access the NAS system 250 through a standard network 220, such as a standard Internet Protocol- or “IP”-based intranet, extranet, or the public Internet. The NAS system 250 is depicted in FIG. 2 as comprising a controller function or control unit 230 and several storage devices or storage subsystems 240, such as IBM's Enterprise Storage Server product, which is a commercially-available high-capacity enterprise storage system. The NAS controller function 230 (which may be comprised of hardware and/or software elements) connects both to the network 220 and to the storage devices 240. Connection between a NAS controller function 230 and a storage device 240 can be made using a standard storage access protocol, such as Fibre Channel, ESCON®, or SCSI. (“ESCON” is an abbreviation for “Enterprise Systems Connection”, and is a registered trademark of IBM. “SCSI” is an abbreviation for “Small Computer System Interface”. The details of FibreChannel, ESCON, and SCSI are not deemed necessary for an understanding of the present invention, and thus these technologies will not be described in detail herein.) The storage device(s) 240 can be integrated with the NAS controller function 230 and packaged as a whole to form a NAS system 250, or the NAS controller function 230 and the storage device(s) 240 can be separate. In the latter case, a NAS controller function 230 is often called a “gateway”, as it provides a gateway to the storage device(s). (References hereinafter to use of NAS systems are intended to include integrated NAS systems as well as NAS gateway implementations.)

A NAS system typically supports one or more file-access protocols such as NFS, WebNFS, and CIFS. “NFS” is an abbreviation for “Network File System”. “CIFS” is an abbreviation for “Common Internet File System”. NFS was developed by Sun Microsystems, Inc. “WebNFS” is designed to extend NFS for use in the Internet, and was also developed by Sun Microsystems. CIFS is published as X/Open CAE Specification C209, copies of which are available from X/Open. These protocols are designed to enable a client to access remotely-stored files (or, equivalently, stored objects) as if the files were stored locally. When these protocols are used in a NAS system, the NAS controller function 230 is responsible for mapping requests which use the protocols into requests to actual storage, as discussed above. (Details of these file access protocols are not deemed necessary to an understanding of the present invention, and will not be described in detail herein.)

As FIG. 3 illustrates, most NAS systems 350 use a simple Web server 330 (which is embedded in, or otherwise included in, NAS system 350) to allow configuration of the NAS system. Using a standard Web browser client 310 to access the configuration subsystem 340 of the NAS, administrators can configure NAS device settings, such as giving users file-access permissions. This approach for configuring a NAS system is quite common with existing systems.

FIG. 4 illustrates, at a high level, components of a NAS system 400. Requests arrive at the NAS system using any of the exported (i.e. supported) protocols. For purposes of illustration, the exported protocols are shown in FIG. 4 as including HTTP 410 (which may be used for configuring the NAS system, as discussed above), CIFS 430, and NFS 450. The requests are received by a corresponding protocol handler component 420, 440, 460, and are passed to the NAS's internal file system 470. One example of this internal file system is the General Parallel File System, or “GPFS”. (See IBM publication “IBM GPFS for AIX: Guide and Reference (SA22-7452)” for more information on GPFS.) The internal file system manages the blocks exported by the storage system from storage 480. Stored content is thus made available to the requesting protocol handler, which formats the proper response message and returns the content to the requester.

A NAS system may be connected to a network which also contains a cluster of Web servers, also known as a “server farm”. As Web servers in the farm receive content retrieval requests, they simply access the NAS system to supply the requested content. This configuration is illustrated in FIG. 5 (see element 500). Note that while this figure shows the NAS system 550 and Web servers 540 connected to a private network 530 that is logically distinct from a public network 520, only one network is necessary—that is, all data passing between clients 510 and NAS system 550 can flow through a single network. In many cases, however, the public network 520 is the Internet and the private network 530 is a local area network or “LAN”. (Components such as load balancing hosts and firewalls have been omitted from FIG. 5 for clarity.)

If content placement on the NAS system is not properly aligned with the distribution pattern of dynamic run-time requests for the content, overall system performance may be seriously degraded and end-user satisfaction may be adversely affected.

What is needed are improved techniques for placing content in distributed computing networks.

### SUMMARY OF THE INVENTION

An object of the present invention is to provide improved techniques for placing content in distributed computing networks.

Another object of the present invention is to determine content placement based upon popularity (or, equivalently, “usage metrics”) of the content.

Yet another object of the present invention is to enable content placement based upon usage metrics that are explicitly specified (e.g. as “expected” usage metrics).

Still another object of the present invention is to enable content placement based upon usage metrics that are observed at run-time.

A further object of the present invention is to enable initial content deployment determinations to be based upon usage metrics.

Another object of the present invention is to enable content redeployment determinations to be based upon usage metrics.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for intelligent placement of content in distributed computing networks. In one aspect, this technique comprises: receiving usage metrics for a particular stored object; and evaluating the received usage metrics to determine whether the particular stored object is stored in an appropriate location, and for moving the particular stored location if not. The technique may further comprise: gathering usage metrics by a server; and sending the gathered usage metrics from the server, wherein the received usage metrics are those sent from the server. A number of alternative approaches to gathering usage metrics, formatting usage metrics for transmission, and sending usage metrics are disclosed.

The present invention may also be used advantageously in methods of doing business, for example by providing improved systems and/or services wherein the placement of content may be managed in an improved manner. Content locations may be controlled using the techniques disclosed herein, such that content may be moved from one location to another in response to dynamically-observed run-time access patterns. Providers of content management services and/or NAS systems may offer these advantages to their customers for a competitive edge in the marketplace.

The present invention will now be described with reference to the following drawings, in which like reference numbers denote the same element throughout.

### BRIEF DESCRIPTION OF THE DRAWINGS

FIG. 1 is a diagram of a server site in which incoming content requests arrive and are serviced, according to the prior art;

FIG. 2 illustrates a typical NAS environment of the prior art;

FIG. 3 is a diagram showing placement of a Web server in a NAS system to allow configuration thereof, according to the prior art;

FIG. 4 is a block diagram which illustrates, at a high level, components of a NAS system of the prior art;

FIG. 5 illustrates a prior art NAS environment which includes multiple servers organized as a server farm;

FIG. 6 illustrates a data structure that may be used to store usage metrics, according to preferred embodiments of the present invention;

FIGS. 7A through 7G depict several representative examples of approaches for associating usage metrics with content, according to preferred embodiments of the present invention; and

FIGS. 8 and 9 provide flowcharts illustrating operation of preferred embodiments of the present invention.

### DESCRIPTION OF PREFERRED EMBODIMENTS

The present invention provides improved techniques for placing content in distributed computing networks. Information about the popularity or usage of content is associated with the content, and may be used to determine where on the physical storage resources of a NAS system the content is most advantageously stored. The information about content popularity may be specified prior to content deployment, and/or may be determined based upon usage metrics that are observed at run-time. The content may be initially stored on the NAS resources based upon usage metrics. The location of particular content may also, or alternatively, be changed based upon usage metrics.

Oftentimes, content creators or those who deploy content within an enterprise have at least a general understanding or expectation of the relative popularity of the content which they create or deploy. For example, a developer who modifies the Web page accessed using the URL (Uniform Resource Locator) “www.ibm.com”, which is the home page address for the IBM Corporation, knows that this page will be accessed quite frequently—and much more often than a page such as “www.ibm.com/legal/copytrade.shtml”, for example, which is a page providing information on copyrights and trademarks of IBM. This knowledge can be leveraged according to the present invention such that the content can be strategically placed at an appropriate location on the NAS resources. (It may also be appropriate in some cases to store content at more than one location on the NAS resources.) Popularity information provided by a content developer or deployer may be useful for initially placing the content. In addition, information which is subsequently learned by the developer or deployer can be used to request changes to content placement. (Note that while information for initial content placement and/or for changing content locations can be obtained from a human user based upon anticipated popularity, the human user may also specify this information based upon usage metrics which have been gathered from actual run-time data, or a combination of these types of information may be used.)

Automated techniques for determining content popularity may also (or alternatively) be used with the present invention. Web servers, for example, are involved in servicing content requests which cannot be handled by downstream cache servers (that is, cache servers which are located in the network path between the content requester and the Web server). A Web server might gather usage metrics by tracking each request it services, and computing the number of requests for each object. An implementation of the present invention may track all objects which are accessed when processing content requests, or, in an optional aspect, support may be provided for monitoring usage metrics only for those objects which are explicitly requested in a content request (i.e. not objects which are accessed due to being embedded within requested objects). Furthermore, in another optional aspect, usage metrics may be gathered selectively—that is, for only those objects meeting certain criteria, such as objects of a particular type (as indicated by their file type or by their content type, for example); objects meeting particular size requirements; or objects which have been identified for tracking purposes (perhaps by specifying a “watch list” of object names, addresses, or other object locator or identifying information). The objects might perhaps be identified using wildcards rather than by specifying a complete object identification, for example to enable fine-tuning the access patterns of objects which are retrieved from one or more key Web sites. Preferably, a configuration interface is used to enable the systems administrator to specify the criteria for selective metrics or to otherwise identify objects to be monitored in a selective manner. The Web server forwards its gathered tracking information to the NAS system for use in determining content placement, as described in detail below.

As an alternative to tracking popularity at a Web server, a content management system (“CMS”) might provide popularity information to the NAS system. For example, the CMS might provide an input location on a form used at content creation time, where this input location enables the user of the CMS to specify the popularity rating of the content. Preferably, this popularity information used by the CMS is integrated with the NAS system such that the possible range of values which the NAS system expects to receive can be determined and shown to the user. (For example, a scale might be used for this purpose, where the scale might indicate that the NAS system uses popularity ratings between 1 and 20, and considers 1 to be the highest rating.) Alternatively, the CMS may provide information to the NAS system about the selections which were offered to the user, so that the NAS system can properly interpret the values it receives. (For example, if the CMS sends a popularity value of “10” to the NAS system, the NAS system needs to know if this value was selected from a range of 1 to 10 or from a range of 1 to 100.)

As yet another alternative, the NAS system might itself track popularity of objects which are retrieved, in a similar manner to that which has been described for Web servers. That is, because a NAS controller function receives requests for particular stored objects and services those requests, the NAS system can gather usage metrics for the objects it stores. And, as discussed earlier, popularity information might be provided by a human such as a content creator/deployer, and an implementation of the present invention may use this type of popularity information in addition to or instead of usage metrics which are obtained in actual system operation.

An implementation of the present invention may support one or more of these sources of input on popularity information. Use of the terms “usage metrics” and “popularity information” are considered interchangeable herein, and usage of either term hereinafter is intended to refer equivalently to values specified as expected operational results as well as values obtained from actual operational results unless otherwise indicated from the context of the reference. (Popularity information supplied by a content creator is typically referred to herein as “popularity information”, rather than “usage metrics”, because in some cases this supplied information is simply an expected value rather than actual usage information.)

Tracking of usage metrics may be done as a real-time operation, and/or after-the-fact analysis may be performed using recorded access information (for example, from an access log file which records information about objects that are accessed). A particular implementation of the present invention may be specifically adapted to track content requests in a particular manner. As one example, logic might be provided in the implementation for creating a table or other data structure to record the URI (Uniform Resource Identifier) or URL of each accessed object and then counting the accesses for those objects. As another example, the implementation might be adapted to processing an explicit specification, such as a list of URIs, of the objects to be tracked. As an alternative to specifically adapting an implementation for tracking a particular type of access, an implementation might include a configuration interface which enables a systems administrator (or other expert, equivalently) to tailor operation of the implementation. A number of options might be provided through such a configuration interface. For example, the administrator might be allowed to specify whether tracking is based upon run-time measurements which are gathered by a Web server expressly for this purpose or upon measurements created by analyzing an already-existing access log file. The administrator might also be allowed to specify criteria for use by the present invention, such as a relative percentage of total access requests or perhaps an absolute number of access requests after which content movement may be indicated. A wide variety of configuration parameters will be suggested to one of skill in the art once the teachings of the present invention are known. A number of such configuration parameters are discussed infra.

Using usage metrics, objects may be initially placed and/or subsequently placed in particular location(s). In preferred embodiments, usage metrics are associated with stored objects. These usage metrics may be provided to a NAS system, and an object placement algorithm is preferably used by the NAS system to determine where the objects should be placed on the NAS resources. Details of the object placement algorithm are outside the scope of the present invention: many different approaches may be used for this purpose, without deviating from the inventive concepts disclosed herein. The more popular objects are preferably distributed across the physical storage resources of the NAS to enable the load on those storage resources to be shared more evenly. As an alternative to the placement decision being made by the NAS system, the NAS system may invoke the services of a system which is specifically designed for use with the present invention for determining where a particular object should be placed based upon usage metrics associated with that object. References herein to the decision being made by the NAS system are intended to include this alternative.

The techniques disclosed herein may optionally be used for objects which are executable, such as servlets, documents encoded as JavaServer Page™ (“JSPs”) or Personal Home Pages (“PHPs”), and so forth. JavaServer Pages™ refers to presentation logic represented using scripting commands for dynamically embedding content into Web documents. PHP is another scripting language that may be used to embed content in Web documents dynamically. (“JSP” and “JavaServer Pages” are trademarks of Sun Microsystems, Inc.) The NAS system may place the executable code on the NAS resources using the techniques disclosed herein.

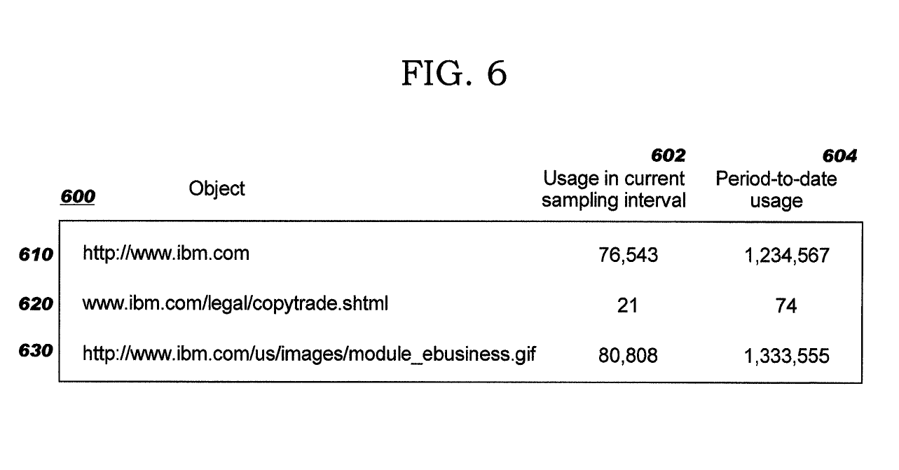

The usage metrics which are gathered or specified by a content creator/deployer may be associated with content in a number of different ways. A table or other data structure may be created to record an object's identifying information (such as its name or address), as well as its usage metric. When gathering usage metrics dynamically at run-time, entries in this table may be used for accumulating a count of accesses to the corresponding object. An example table 600 is illustrated in FIG. 6. This example table 600 shows that for an object 610, which happens to be a highly popular Web page, the number of accesses within a current sampling interval or measurement period (see column 602) is 76,543; for another object 620, which is a less popular Web page, the number of accesses within the same sampling interval is 21. An object 630, which in this example is a graphic image embedded within (i.e. referenced from) Web page 610, is also accessed quite frequently, having 80,808 accesses in the sampling period. (The numeric values shown in the examples are merely for purposes of illustration. The values in column 602, and also in column 604, have been selected to suggest that the image 630 is accessed every time Web page 610 is accessed, and from other Web pages as well.) The example table 600 also shows an optional feature of the present invention whereby usage metrics may be kept not only for a current sampling interval, but also may be remembered over a longer timeframe as well (see column 604). (This optional information might be useful, for example, in detecting non-representative spikes in access patterns.)

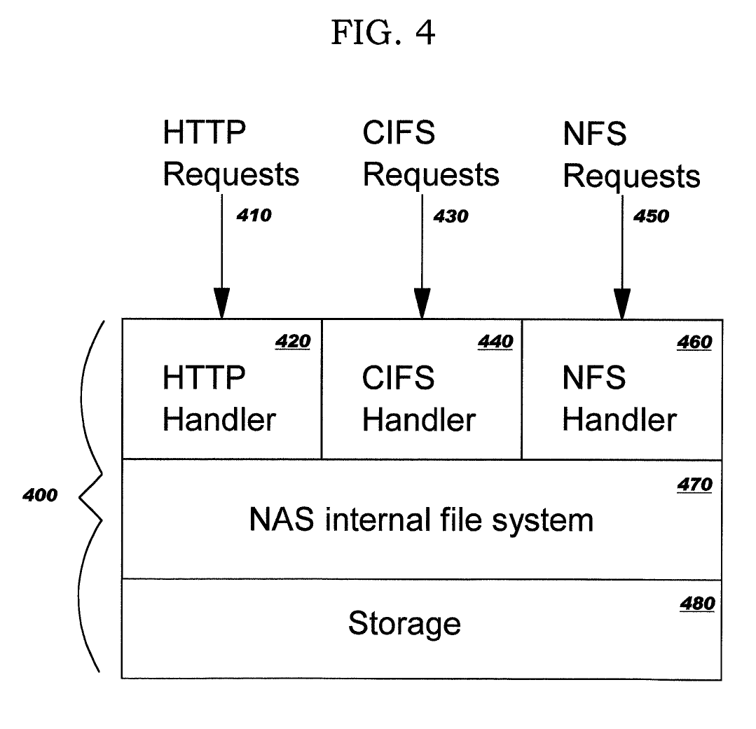

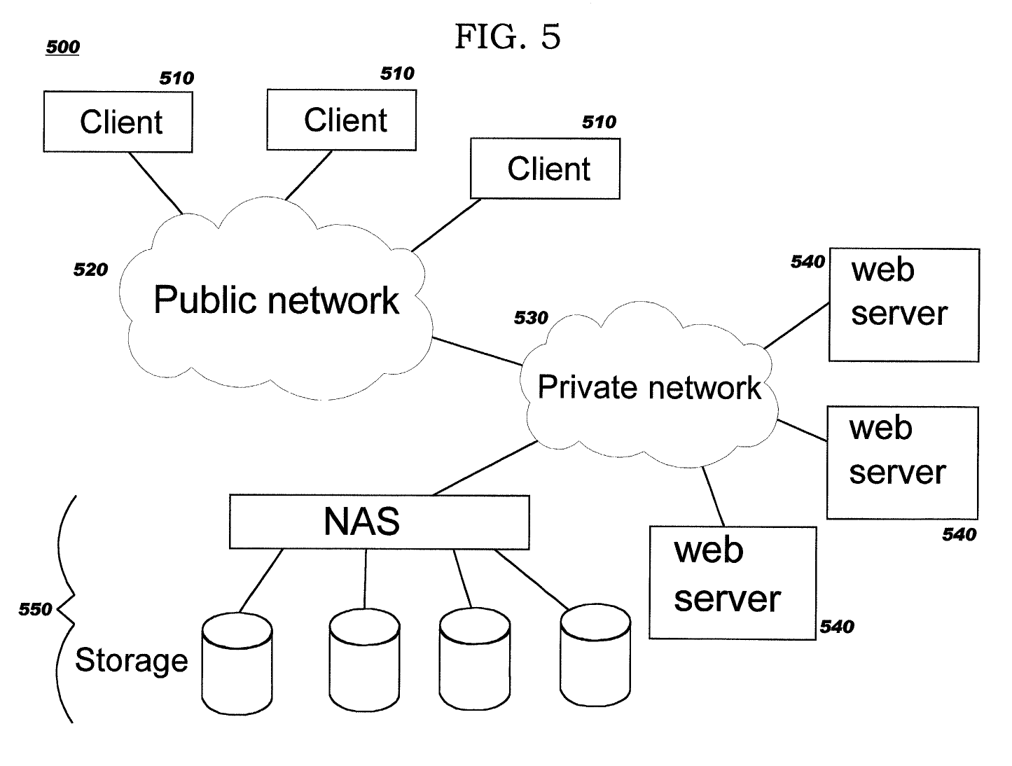

In preferred embodiments of the present invention, a Hypertext Transfer Protocol (“HTTP”) POST request message (or, alternatively, an HTTP PUT request message, or a message which is semantically similar to HTTP POST or PUT in another protocol) is used for sending messages to the NAS system to convey an object's popularity, and meta-data information is included in the message to indicate this information. References hereinafter to HTTP POST or PUT are considered equivalent, and are also to be considered as representative of messages in other protocols (such as the Wireless Session Protocol, or “WSP”). The destination of these messages is preferably a special control URL, with which logic is accessible that is adapted to processing the usage metric information. (Refer to HTTP requests messages 410 of FIG. 4, and HTTP content handler 420. This content handler may be used to deliver the messages to the special control URL.) Preferably, the HTTP POST/PUT request messages are sent “out of band”, that is, separate from requests for content. The messages are preferably sent in response to a triggering event. Triggering events at a Web server include, by way of illustration: expiration of a timer, after which gathered information is sent from the Web server to the NAS system; reaching a threshold measurement for requests for one or more objects; analyzing an access log (and then providing values of the analysis to the NAS system); or in response to a query from the NAS system. (Analyzing the log file may alternatively be performed by another component, which then preferably sends usage metrics to the NAS system using HTTP request messages in the same manner described herein.) Triggering events at a CMS include: receiving popularity information for an object when the object is created/deployed; receiving revised popularity information for an already-deployed object (which may be received, for example, from the user via a special “update popularity metrics” window or option); or expiration of a timer, after which gathered information is sent from the CMS to the NAS system.

In alternative embodiments, rather than transmitting usage metrics with HTTP messages, the information may be passed on other message flows. For example, a Web server typically communicates with a NAS system using file system messages such as Open, Close, Read, and Write. When requesting a file access from the NAS (using, for example, an Open message), usage metrics may be sent as meta-data on the access message itself.

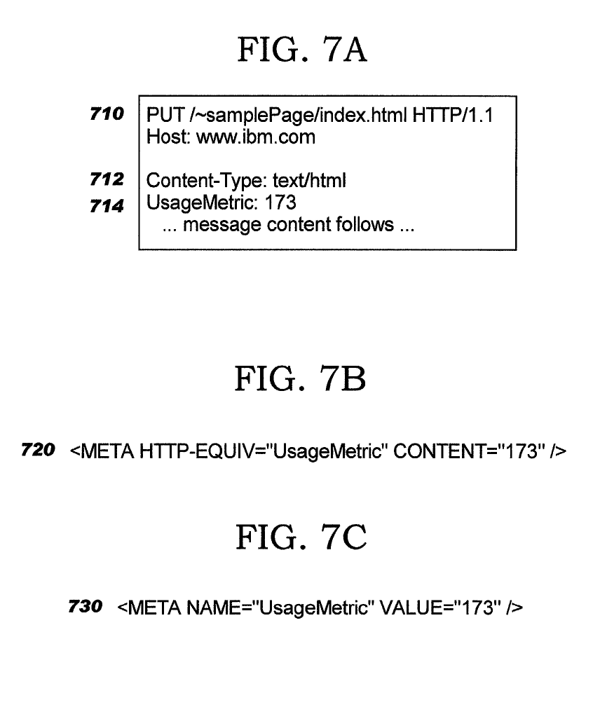

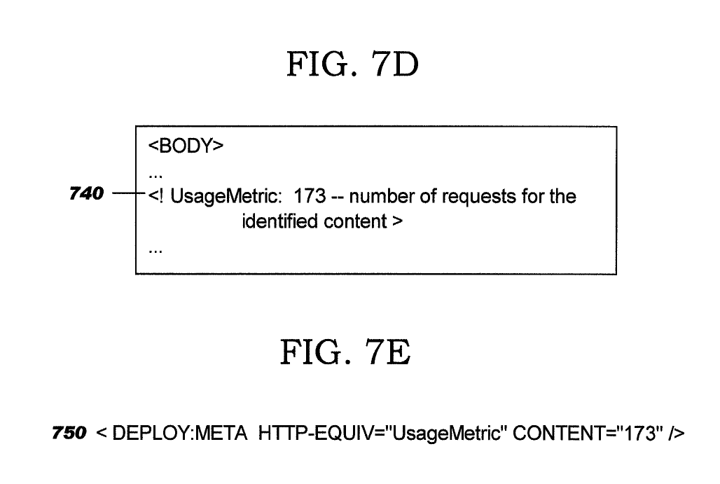

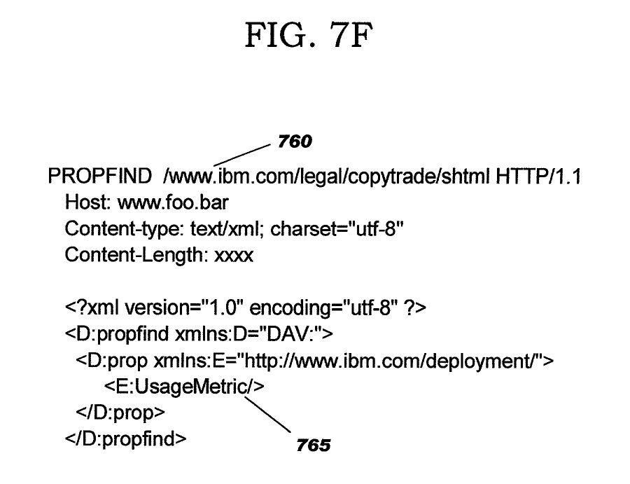

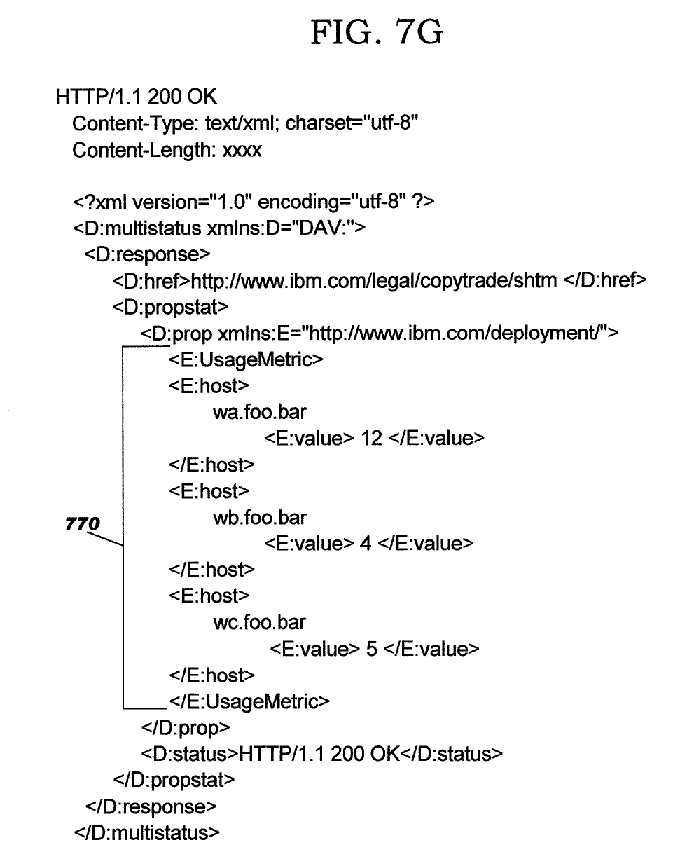

FIGS. 7A through 7E illustrate several different syntax formats that may be used for conveying usage metrics within an HTTP POST or PUT request message. These examples illustrate syntax for use within the request message header; other approaches may be used alternatively, including but not limited to conveying the information within one or more cookies of the request header rather than as separate headers.

FIG. 7A illustrates an example of specifying usage metrics using HTTP syntax directly. The examples in FIGS. 7B through 7D represent three formats that may be used in HTML syntax. The example in FIG. 7E uses the Extensible Markup Language (“XML”). These examples will now be discussed in more detail. (FIGS. 7F and 7G, described below, illustrate an example of obtaining usage metrics on request by issuing a WebDAV query and receiving a response thereto.)

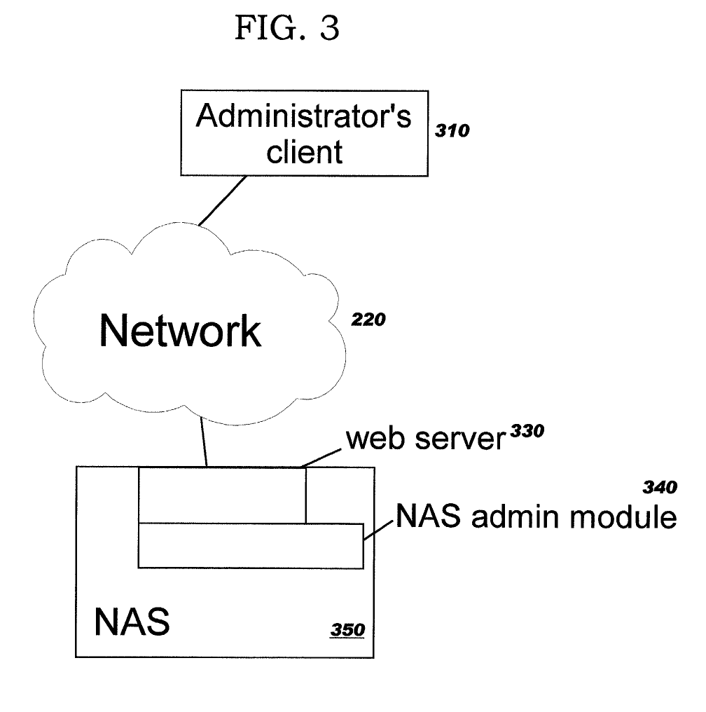

Use of the HTTP header syntax, as illustrated in FIG. 7A, enables usage metrics for any type of content object to be transmitted using a single syntax form. Assuming that an HTTP GET request such as “GET http://www.ibm.com/samplePage.html HTTP/1.1” is received at a Web server for which content request tracking is operating, the usage metrics of this object are updated. At some point, suppose an HTTP POST/PUT request message is sent to the Web server (which is preferably running on the NAS; see element 330 of FIG. 3) to indicate this object's popularity. The request header shown in FIG. 7A indicates the following information: (1) the content of this message pertains to relative location “samplePage/index.html”, and this message is encoded using HTTP 1.1 (see element 710); (2) the content type, in this example, is “text/html” (see element 712); and (3) the usage metric for the corresponding object is, for this example, 173 (see element 714). The units of measure or other interpretation of the usage metric value may vary from one implementation to another without deviating from the scope of the present invention. Assume for purposes of illustration that the number 173 in the examples of FIGS. 7A through 7E represents 173 references to the corresponding object within the measurement interval of interest. The “UsageMetric” header shown at 714 of FIG. 7A is an example of the header syntax that the content servers which supply usage metrics (such as Web servers and/or content management systems) may generate, and that the code residing at the special control URL may search for in the metric information created by those servers, according to preferred embodiments of the present invention. Alternatively, other names for this header might be used, or individual headers might be used to separately convey factors which together comprise the overall usage metrics (such as a header for the number of access requests, a header for the length of the measurement interval or perhaps separate headers for the start and end of the measurement interval, and so forth). In this latter case, the NAS system may store these values separately upon receipt (e.g. for later use by an algorithm adapted to using those values as input parameters), or might use them to compute a result to be used in deployment determinations and then store the computed result.

With reference to the examples in FIGS. 7A through 7E, it should be noted that usage metrics may be indicated in ways other than by transmitting accumulated counter values. As one example, the counter value may be analyzed by the transmitting system, and replaced with a mnemonic prior to transmission. For example, mnemonics such as “high”, “medium”, and “low” might be substituted for particular ranges of counter values. (In actual operation, more than three distinct classifications of popularity are expected to be required, and therefore references herein to very simple classifications are merely for purposes of illustration.) As a second example, a scaled value might be used in the transmission (such as a number between 1 and 100, where a scaling algorithm converts a raw value into a value within this range). As another example, the counter value might be used to compute a relative percentage of accesses, and this computed number might then be used in the transmission. As yet another example, it might be useful in some cases to transmit a ranking, such as “21/157,372” for object 620 of FIG. 6, where this ranking example indicates that object 620 was accessed 21 times out of a total of 157,372 accesses for all objects represented by the stored counters of column 602. As still another example, a relative ranking value might be supplied. With reference to the table 600 in FIG. 6, for example, the values to be transmitted would be in the range of “1/3” to “3/3” when using this approach.

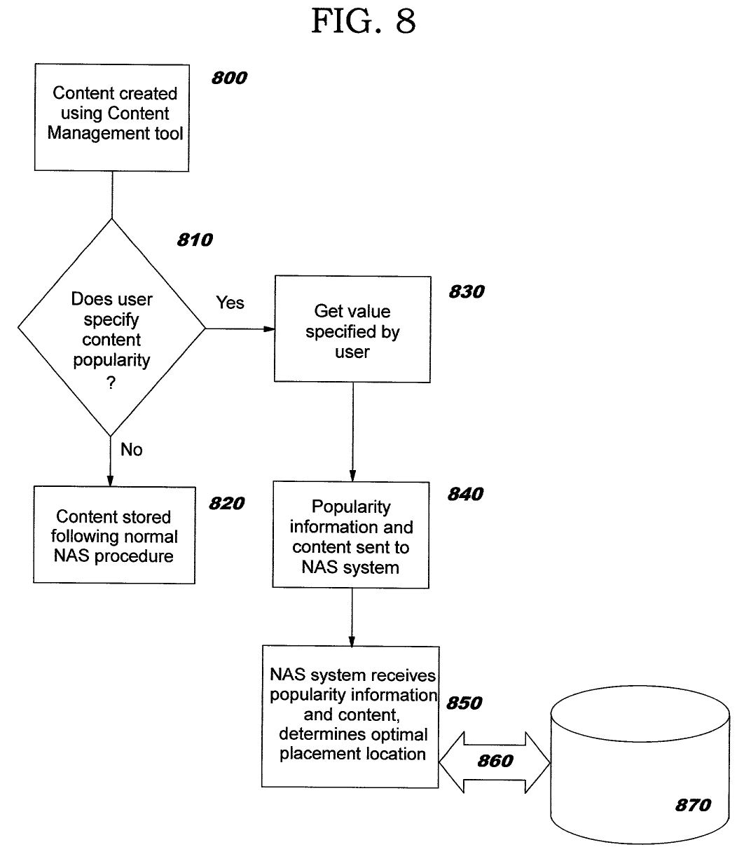

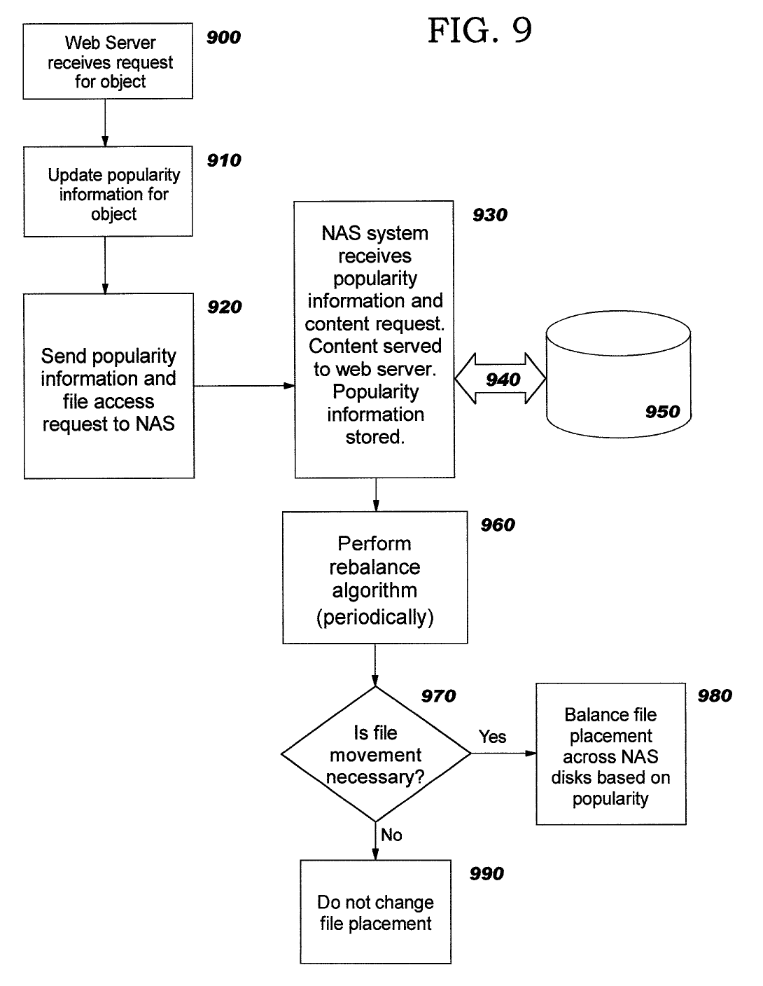

Markups in other markup language objects, such as HTML and XML, may be used as alternatives to the format shown in FIG. 7A. For HTML, one example of an alternative format uses the “HTTP-EQUIV” attribute on a “META” tag, as shown at 720 in FIG. 7B. In this example, the syntax “UsageMetric” has been used as the value of the HTTP-EQUIV attribute to name the usage metric, thereby conveying information which is analogous to element 714 in FIG. 7A. A META element (such as element 720 in FIG. 7B) may be used to identify properties of a document. An HTTP-EQUIV attribute on a META tag may be used in markup language documents to explicitly specify equivalent information that an HTTP server should convey in the HTTP response message with which the document is transmitted. Information on the META tag can be found in Request For Comments (“RFC”) 2518 from the Internet Engineering Task Force, which is entitled “HTTP Extensions for Distributed Authoring—WEBDAV” (February 1999), as well as on the Internet at location http://wdvl.comlAuthoring/HTML/Head/Meta/HTTP.html. Location www.webdav.org on the Internet also provides general information about the initiative for extending the HTTP protocol to include distributed authoring and versioning syntax. Use of WebDAV requests enables accessing the meta-data property information remotely, such that the NAS system may query the usage metric information stored at/by the Web server and/or CMS, as an alternative to using the server push techniques illustrated by FIGS. 8 and 9 (described below). (Refer to the discussion of FIGS. 7F and 7G, below, for examples of using WebDAV for obtaining usage metric information.)

Another example of an alternative format for use with HTML documents is the META tag with a “NAME” attribute, rather than an HTTP-EQUIV attribute. This alternative is illustrated in FIG. 7C at element 730. The NAME attribute on a META tag or element identifies a property name, and the VALUE attribute then specifies a value for that named property. For more information on use of the NAME attribute, refer to RFC 2518 or to http://wdvl.com/Authoring/HTML/Head/Meta on the Internet.

A third example of an alternative format for use with HTML documents uses specially-denoted comments within the body of an HTTP POST/PUT request message, as illustrated at 740 in FIG. 7D. As shown therein, this example uses a keyword “UsageMetric” following by a colon, followed by a numeric value. Preferably, the content with which this numeric value is identified in the message body using its URL or URI, or using parameters or other headers of the message. (Similarly, with reference to all the syntax examples in FIGS. 7A through 7E, the object corresponding to the specified usage metric is preferably identified in the same manner.) Note that although an object may move from one location to another on the NAS resources, its URL does not change, and therefore a constant URL may be used to identify the stored content. The NAS is responsible for revising its URL-to-storage location mapping information when an object is moved.

With XML documents, a namespace is preferably used to introduce a tag set for conveying usage metrics, and may be designed to resemble the HTML markup if desired. An example of this approach is shown at 750 in FIG. 7E, where a tag value “DEPLOY” denotes this document element as corresponding to a content deployment tag set which has been defined to include the META, HTTP-EQUIV, and CONTENT keywords which are specified on example tag 750.

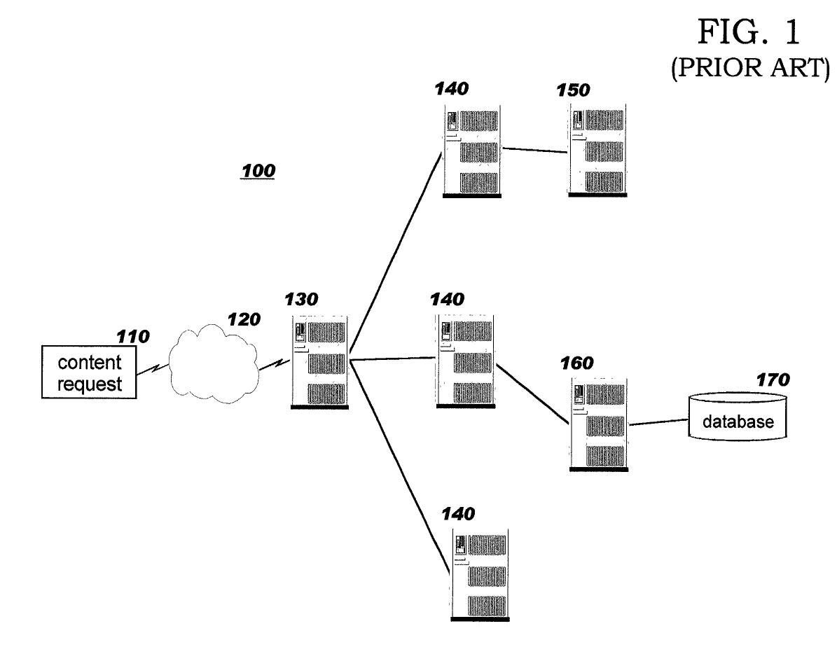

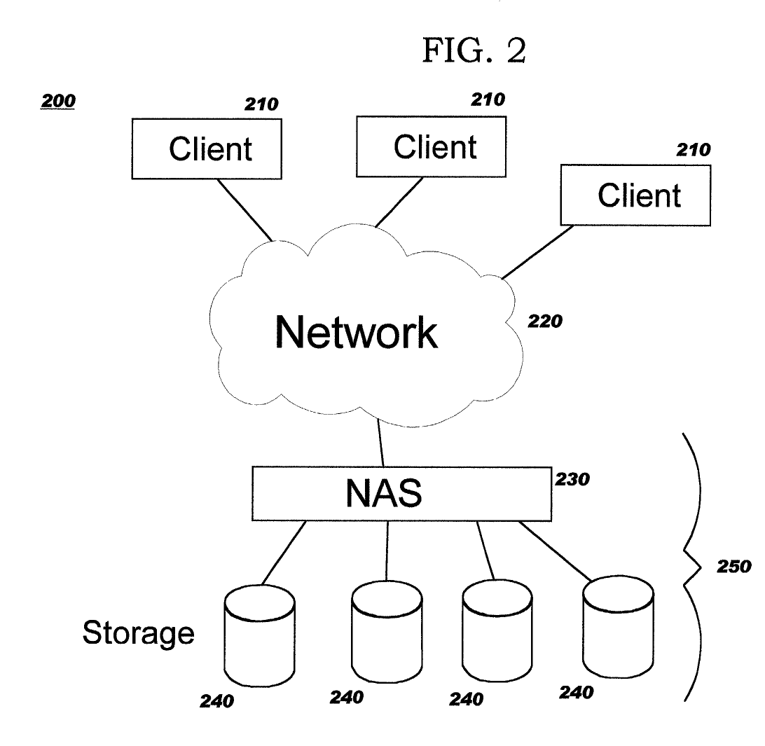

Referring now to FIGS. 7F and 7G, an example is illustrated of obtaining usage metric meta-data on request by issuing a WebDAV query and receiving a response thereto. When using WebDAV, it is likely that the hosting servers, such as Web server 140 in FIG. 1, which share a URL namespace are able to share meta-data properties about the namespace (for example, by way of a content manager). The usage metric property for a given object might then be multi-valued, wherein a given one of the values represents the usage accumulated by one of the hosting servers for that object in the URL namespace. In this case, a single WebDAV request might retrieve usage metrics for all of the servers capable of serving the content (e.g. all the servers in a server farm), as illustrated in FIG. 7F. Or, a single WebDAV request might be formulated such that it retrieves usage metrics for all of the pages served by a particular server. (This alternative has not been illustrated, but preferably comprises specifying a wildcard in the object identifying information.) The example query in FIG. 7F requests stored information that uses the “UsageMetric” property name (see element 765) associated with the content “www.ibm.com/legal/copytrade.shtml” (see element 760), which is element 620 of FIG. 6. The response message illustrated in FIG. 7G shows that values for this property are being provided from three Web servers “wa.foo.bar”, “wb.foo.bar”, and “wc.foo.bar” (see element 770), where these three Web servers may correspond to the servers 140 shown in FIG. 1. As shown in the example, the first of these servers has accumulated a total of 12 requests for this page; the second has accumulated a total of 4 requests; and the third has accumulated a total of 5 requests.

FIG. 8 depicts logic which may be used to implement a preferred embodiment of the present invention wherein messages are sent from a CMS to the NAS system to convey object popularity information. The logic depicted represents a scenario wherein popularity information is transmitted at the same time as content is transmitted for storing on the NAS resources. It will be obvious to one of skill in the art how this logic may be modified to transmit popularity information at a subsequent time. (For example, the logic may begin with the test in Block 810, which is altered to detect a triggering event.) In the latter case, references to receiving content and popularity information are to be interpreted as receiving two separate messages. It will also be obvious how this logic is modified for processing popularity information that is received in response to a revision of popularity information supplied by the user (i.e. without corresponding content for deployment). Preferably, popularity information is transmitted from the CMS using HTTP POST/PUT request messages, although alternatively, this information may be transmitted as meta-data in the same file access as the content to be deployed. (It should be noted that while the discussions herein are directed toward popularity information being provided to the CMS by a user, an appropriately adapted CMS may include logic to predict popularity. Receiving and analyzing this type of predicted popularity information is also within the scope of the present invention.)

At Block 800, the content is created or deployed, using a CMS tool. According to the present invention, the content creation/deployment process is augmented to enable the user to specify popularity information. Thus, at Block 810, a test is made to see if the user specified content popularity for this content. If not, then control passes to Block 820 where the content is deployed using the normal procedure (e.g. by sending a deployment request to the NAS system, where this deployment request does not contain usage metrics). Alternatively, a null value might be transmitted in this case, such that all deployment requests include a usage metric parameter. Default usage metrics might also be supported, whereby the user signifies his intent to accept the default value when Block 810 has a negative result; in this case, Block 820 sends the default value to the NAS system.

When the test in Block 810 has a positive result, then the value specified by the user is obtained (Block 830). A deployment request is formatted by the CMS and sent to the NAS system (Block 840). This deployment request may include the popularity values, or a separate request containing this information may be transmitted, as described above. As discussed earlier, the popularity values may be conveyed in several different ways, such as converting a numeric value to a mnemonic or a scaled value, and so forth.

Upon receiving the deployment request and popularity information (Block 850), the NAS deploys the content and uses the popularity information to determine an optimal location for placing this content. Preferably, the placement algorithm makes this decision based upon the current layout of content on the devices of the NAS, where a dynamic determination of such information may be performed by consulting stored information as shown at 860, 870.

FIG. 9 illustrates another way in which usage metrics may be gathered and processed by the present invention, whereby Web servers (which may be configured as a server farm) gather and transmit usage metrics to the NAS system. The logic shown in FIG. 9 may be used when usage metrics are transmitted on the content request message, for example in a modified file access message, as well as when the usage metrics are provided on a separate HTTP POST/PUT request message. (Therefore, references to receiving a content request and usage metrics are not intended to imply that the usage metrics arrive on the content request message.) As explained with reference to FIG. 8, the logic depicted represents a scenario wherein usage metrics are transmitted at the same time a content request is transmitted from the Web server, and it will be obvious to one of skill in the art how this logic may be modified to process usage metrics transmitted at a subsequent time.

At Block 900, a particular Web server receives a request for an object. This request causes the accumulated metrics to be updated (Block 910). The Web server then requests the content from the NAS, preferably using a file access message of the prior art, and may also send a message containing usage metrics for the requested object. Alternatively, the usage metrics may be sent at a later time, in response to a triggering event. (Refer to the discussion above of FIGS. 7A through 7E regarding how an HTTP POST/PUT request message may convey usage metrics to a Web server located on the NAS system.)

The NAS receives the message(s) conveying usage metrics and the content request (Block 930). The requested content is served to the requesting Web server, using prior art techniques (see elements 940, 950). The usage metrics may then be stored (or, alternatively, they may be processed upon receipt). In preferred embodiments, a placement/rebalancing algorithm is executed periodically (for example, upon expiration of a delay timer) using the usage metrics which have been received to determine whether it is necessary to rebalance the location of the content (Block 960). The placement algorithm may make this decision with regard to one object or more than one object, using its knowledge of the associated usage metrics. Access costs are affected by an object's location. Therefore, when the present invention is used to place content optimally on the devices of a NAS, the placement decision comprises determining where on the NAS resources the files for popular objects should be stored. It may be desirable to place these files around the outside sectors of the NAS, for example. Furthermore, it may be desirable to spread the files for the most popular objects evenly across the NAS devices, such that accesses to the physical disks are balanced. Thus, Block 970 tests the output of the balancing algorithm to see if file movement is necessary. If not, then the processing of FIG. 9 ends for this object without moving the file, as shown at Block 990. Otherwise, control transfers to Block 980, where file movement is performed to balance the file placement based on the usage metrics.

In an embodiment where usage metrics are requested by the NAS system from one or more Web servers, the logic in FIG. 9, beginning at Block 920, may be used to process the information received after a WebDAV query (or, equivalently, a query supported by a similar technique) has been issued. In this case, references in FIG. 9 to receiving a content request and serving content should be ignored.

As has been demonstrated, the present invention provides advantageous techniques for improving efficiency and/or speed of servicing content requests by placing the content in optimal locations on NAS resources. Cooperation techniques have been described for exchanging usage metrics between the NAS system and a CMS and/or Web servers. The disclosed techniques enable retrieving popular content more quickly, and may increase the scalability of computing resources in the environment by maximizing throughput from the NAS and Web servers.

The disclosed techniques may also be used to implement improved methods of doing business. For example, content distribution systems may be provided wherein the placement of content may be managed in an improved manner. Content locations may be controlled using the techniques disclosed herein, including the initial placement of content and moving content from one location to another or deploying content at additional locations in response to dynamically-observed run-time access patterns.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of efficiently serving content in a distributed computing environment, comprising steps of:
receiving usage metrics for a particular stored object; and
evaluating the received usage metrics to determine whether the particular stored object is stored in an appropriate location, and moving the particular stored location if not.

2. The method according to claim 1, wherein the usage metrics are received from a server.

3. The method according to claim 1, wherein the received usage metrics are gathered by a system responsible for storing the particular stored object.

4. The method according to claim 1, wherein the usage metrics are encoded in a Hypertext Transfer Protocol message header.

5. The method according to claim 1, wherein the usage metrics are encoded using syntax of a markup language.

6. The method according to claim 5, wherein the markup language is HTML (“Hypertext Markup Language”).

7. The method according to claim 6, wherein the syntax comprises a “META” tag using an “HTTP-EQUIV” attribute syntax.

8. The method according to claim 6, wherein the syntax comprises a “META” tag using a “NAME” attribute syntax.

9. The method according to claim 6, wherein the syntax comprises a specially-denoted comment.

10. The method according to claim 5, wherein the markup language is XML (“Extensible Markup Language”).

11. The method according to claim 1, wherein the usage metrics are received in response to a query for remotely-stored usage metric information.

12. The method according to claim 11, wherein the query uses a WebDAV request.

13. The method according to claim 12, wherein a response to the WebDAV request specifies usage metrics gathered by at least one server.

14. The method according to claim 4, wherein the usage metrics are encoded using one or more cookies.

15. The method according to claim 1, wherein the usage metrics are encoded in a Wireless Session Protocol message header.

16. The method according to claim 1, wherein the usage metrics are expected popularity values.

17. The method according to claim 16, wherein the expected popularity values are provided by a user.

18. The method according to claim 16, wherein the expected popularity values are predicted by a content management system.

19. The method according to claim 1, wherein the usage metrics are received as meta-data on a file access message.

20. The method according to claim 1, further comprising steps of:
gathering usage metrics by a server; and
sending the gathered usage metrics from the server; and
wherein the received usage metrics are those sent from the server.

21. The method according to claim 20, wherein the sending step operates in response to a triggering event.

22. The method according to claim 21, wherein the triggering event comprises expiration of a timer.

23. The method according to claim 21, wherein the triggering event comprises exceeding a threshold.

24. The method according to claim 21, wherein the triggering event comprises receiving a query for the usage metrics.

25. The method according to claim 20, wherein the gathering step further comprises gathering the usage metrics by analyzing an access log.

26. The method according to claim 20, wherein the gathering step further comprises gathering the usage metrics by tracking access requests at the server.

27. The method according to claim 1, wherein the usage metrics are expressed as a mnemonic.

28. The method according to claim 1, wherein the usage metrics are expressed as a scaled number.

29. The method according to claim 1, wherein the usage metrics are expressed as a percentage of access requests.

30. The method according to claim 1, wherein the usage metrics are expressed as an actual number of access requests.

31. The method according to claim 1, wherein the usage metrics are expressed as a ranking.

32. A system for efficiently serving content in a distributed computing environment using a network-attached storage (“NAS”) system, comprising steps of:
means for receiving, by a component of the NAS system, usage metrics for a particular stored object; and
means for evaluating the received usage metrics to determine whether the particular stored object is stored in an appropriate location, and for moving the particular stored location if not.

33. The system according to claim 32, further comprising:
means for gathering usage metrics by a server; and
means for sending the gathered usage metrics from the server; and
wherein the received usage metrics are those sent from the server.

34. A computer program product for efficiently serving content using a network-attached storage (“NAS”) system, the computer program product embodied on one or more computer-usable media and comprising:
computer readable program code means for receiving, by a component of the NAS system, usage metrics for a particular stored object; and
computer readable program code means for evaluating the received usage metrics to determine whether the particular stored object is stored in an appropriate location, and for moving the particular stored location if not.

35. The computer program product according to claim 34, further comprising:
computer readable program code means for gathering usage metrics by a server; and
computer readable program code means for sending the gathered usage metrics from the server; and
wherein the received usage metrics are those sent from the server.
